(19) United States
(12) Patent Application Publication
(10) Pub. No.: US 2014/0318410 A1
(43) Pub. Date: Oct. 30, 2014

(54) LOCOMOTIVE WITH VARIABLE POWER MODULES

(71) Applicant: PROGRESS RAIL SERVICES CORPORATION, ALBERTVILLE, AL (US)

(72) Inventors: John Franklin Kral, Plainfield, IL (US); Jeffrey Holt Wright, Edelstein, IL (US); Sidarta Fornari Beltramin, Curitiba - Parana (BR); Luis Roberto van den Berg, Curitiba (BR)

(73) Assignee: PROGRESS RAIL SERVICES CORPORATION, ALBERTVILLE, AL (US)

(21) Appl. No.: 13/871,374

(22) Filed: Apr. 26, 2013

(51) Int. Cl. B61C 3/00; B60R 16/02

(52) U.S. Cl. CPC B61C 3/00; B60R 16/02
USPC 105/50; 307/9.1; 307/52; 320/107; 307/24; 105/61

(57) ABSTRACT

A locomotive includes a plurality of axles and a plurality of pairs of wheels, each pair of wheels being connected to one of said axles. The locomotive also includes a plurality of traction motors, each traction motor operably attached to at least one of the axles. The locomotive includes a power system including at least one power module, the power system being configured to provide power to the traction motors. The locomotive includes a controller configured to receive a control signal indicative of a locomotive powering mode and determine a number of power modules operably connected to the power system and, based on the number of power modules operably connected to the power system and the control signal, send a command signal to the power system for operating the power system.

### TECHNICAL FIELD

This disclosure relates generally to power systems and, more specifically, to a locomotive having a variable number of power modules.

### BACKGROUND

Mobile machines, like locomotives, are known to include a power system for generating power. For example, a power system may include one or more electric motors, one or more generator units, and a power-transfer system for transferring power from the one or more generator units to the one or more electric motors. A generator unit may include an engine driving a generator to produce electricity for the power system, for example, to provide power to be transferred to the one or more electric motors through the power-transfer system.

At least a portion of the power system (e.g., a generator unit) may be enclosed within a housing of the mobile machine, for example, to protect the power system from environmental factors. At least a portion of the power system (e g., a generator unit) may be in an interchangeable power module. In such a power module, the power system may be positioned within a container and provide connection lines (e.g., mechanical and electrical lines) to connect the power module to the mobile machine.

As the physical load a mobile machine is transporting may vary, the power requirements of the machine may also change as a result. As the weight and size constraints of the mobile machine may limit the size available for power modules, it may be desirable to provide a design that may be quickly tailored to the power requirements of a particular mobile machine.

One solution for accommodating multiple power systems on a locomotive is described in U.S. Pat. No. 6,474,242 (“the '242 patent”). The '242 patent is directed to a rail vehicle system that has connecting bogies, supply units, control units, and transportation units, which can be placed on the connecting bogies in order to form a train with a modular construction. The connecting bogies contain at least two axles, one of which is equipped with an electrical drive/brake unit, and which are configured to be separable. The supply units may contain vital devices such as current collectors, transformers, and power converters for extracting power from a contact line and feeding it back into the contact line or converters of mechanical energy into electrical energy. The control units can be configured to be independent of current and load. The transportation units may differ according to whether they are for transporting passengers or goods and according to the type of good being transported. The interfaces of all of the units are uniform and can be interchanged.

The solution provided by the '242 patent may suffer from a number of possible drawbacks. For example, while the '242 patent discloses arranging the engine in a modular power module, the '242 patent does not provide for a mobile machine that can operate with a variable number of power modules. Thus, locomotives according to the '242 patent would still be required to carry multiple power modules, even if only one power module was needed to power locomotive (and its load) for a particular trip.

The present disclosure may be directed to mitigating or overcoming one or more of the problems set forth above and/or other problems in the art.

### SUMMARY

According to one aspect, the disclosure is directed to a locomotive including a plurality of axles and a plurality of pairs of wheels, each pair of wheels being connected to one of said axles. The locomotive may also include a plurality of traction motors, each traction motor operably attached to at least one of the axles. The locomotive may also include a power system including at least one power module, the power system being configured to provide power to the traction motors. The locomotive may also include a controller configured to receive a control signal indicative of a locomotive powering mode and determine a number of power modules operably connected to the power system and, based on the number of power modules operably connected to the power system and the control signal, send a command signal to the power system for operating the power system.

In accordance with another aspect, the disclosure is directed to a computer-implemented method of controlling a locomotive having a power system including at least one power module. The method may include receiving, via a controller, a control signal indicative of a locomotive powering mode and determining a number of power modules operably connected to the power system. The method may also include, based on the number of power modules operably connected to the power system and the locomotive powering mode, sending, via the controller, a command signal to the power system configured to operate the power system.

According to another aspect, the disclosure is directed to a power system. The power system may include a power connector configured to be able to operably connect a maximum number of power modules, wherein the maximum number is greater than one. The power system may also include at least one power module operably connected to the power connector. The power system may also include a controller configured to receive a control signal indicative of a locomotive powering mode and determine how many power modules are operably connected to the power connector. The controller may also be configured to, based on the number of power modules operably connected to the power connector and the control signal, control the power system.

### BRIEF DESCRIPTION OF THE DRAWINGS

FIG. 1 is a side view of an exemplary embodiment of a locomotive including two power modules mounted thereon.

FIG. 2 is a side view of an exemplary embodiment of a locomotive including one power module and one balancing weight mounted thereon.

FIG. 3 is a schematic diagram of an exemplary embodiment of a power module.

FIG. 4 is a schematic diagram of an exemplary embodiment of a power system having two power modules.

FIG. 5 is a flowchart depicting an exemplary embodiment of a method of controlling a power system of a locomotive.

### DETAILED DESCRIPTION

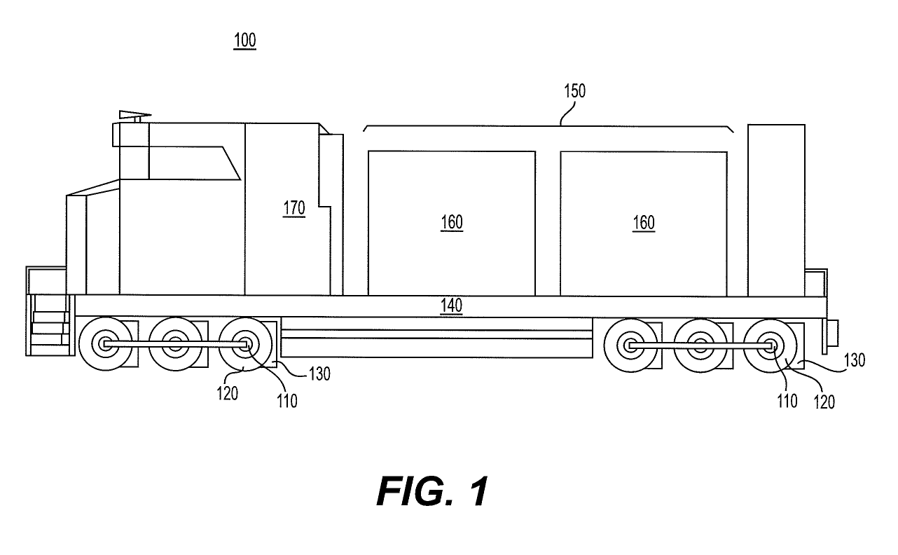

FIG. 1 illustrates an exemplary embodiment of a locomotive 100 in which systems and methods of controlling a locomotive with a variable number of power modules may be implemented consistent with the disclosed exemplary embodiments. For example, locomotive 100 may include a plurality of axles 110 and a plurality of pairs of wheels 120, with each pair of wheels 120 connected to one of said axles 110. Locomotive 100 may also include a plurality of traction motors 130 for supplying power to wheels 120. At least one of axles 110 may be rotatably connected to each of traction motors 130. During powering of locomotive 100, traction motors 130 may operate to propel locomotive 100. In addition, locomotive 100 may have a chassis 140 connected, directly or indirectly, to axles 110. Locomotive 100 may also include a power system 150 including at least one power module 160, and power system 150 may be configured to provide power to traction motors 130. Any number of power modules 160 sufficient to power locomotive 100 may be utilized.

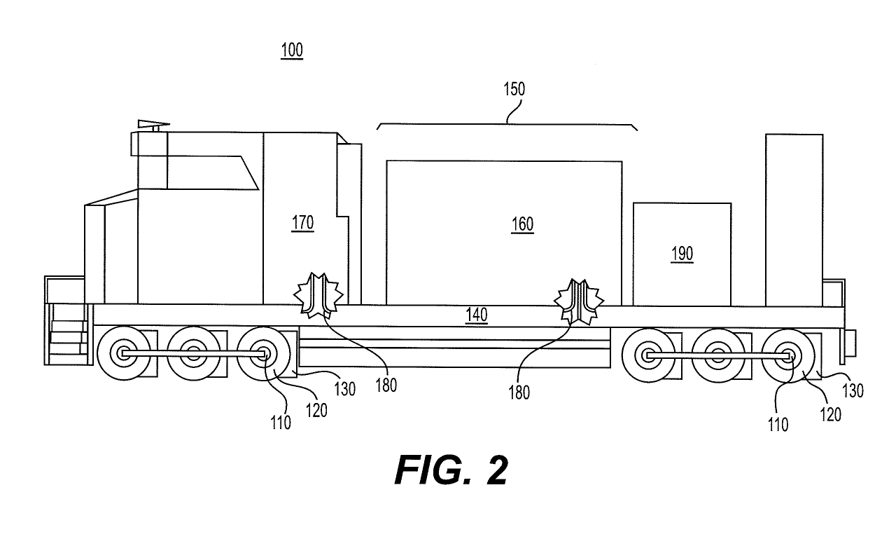

In the exemplary embodiment shown in FIG. 1, locomotive 100 may include two power modules 160 aligned on chassis 140 along a line that extends substantially in the direction of travel of locomotive 100. Chassis 140 may be configured to carry a maximum number of power modules 160. For example, for exemplary locomotives 100 shown in both FIGS. 1 and 2, each chassis 140 is configured to carry a maximum of two power modules 160. According to some embodiments, as illustrated in FIG. 2, locomotive 100 may carry less than the maximum number of power modules 160. In some instances, an optional balancing weight 190 may be added to chassis 140 in place of a power module 160. Balancing weight 190 may be used, for example, to balance locomotive 100 when power system 150 includes fewer power modules 160 than the maximum.

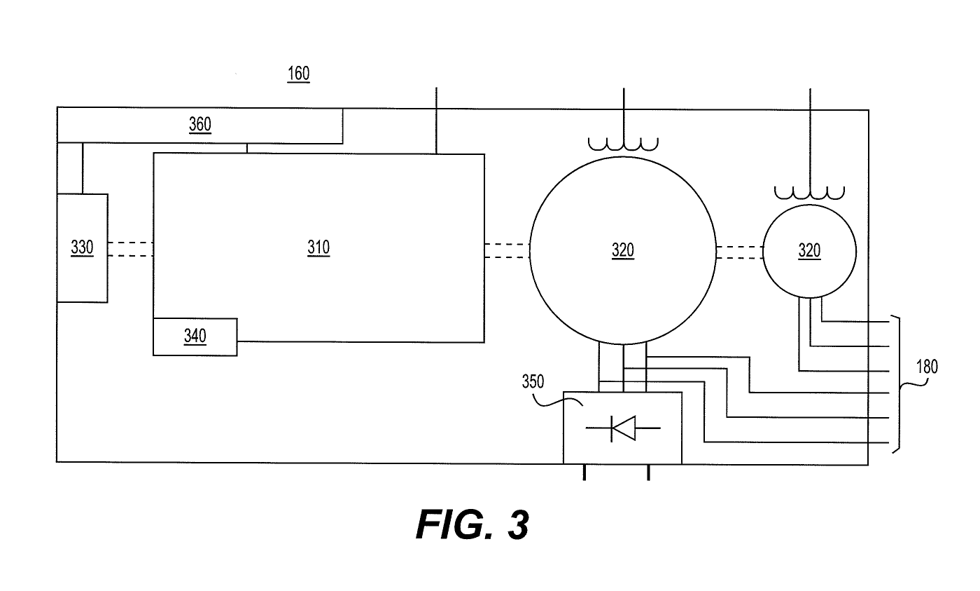

FIG. 3 illustrates an exemplary power module 160. Each power module 160 may produce power that may be transferred, for example, to one or more traction motors 130 to drive wheels 120. Power module 160 may be connected to a frame (not shown) at least partially enclosed by a frame that allows for power module 160 to be removed and/or added to chassis 140 by, for example, a crane or a forklift. The frame may also provide structural rigidity for supporting at least a portion of a power system 150 including, for example, an engine 310 configured to drive one or more generators 320. Further, power system 150 may include one or more auxiliary components (e.g., a radiator, an engine/generator coupling, and an aftercooler). For example, power module 160 may include a hydraulic power pack 330 that may also be driven by engine 310. In addition, power module 160 may include a starter 340 to initiate the operation of engine 310. Power module 160 may also include one or more rectifiers 350 operably connected to one or more generators 320 and/or a cooling system 360 operably connected to engine 310. According to some embodiments, one or more of the auxiliary components of power system 150 may be external to power module 160.

According to some embodiments, power module 160 may include one or more power connectors 180 capable of being connected to locomotive 100 to transmit energy, material, and/or other information between power module 160 and locomotive 100. For example, power connector 180 may include connection lines from locomotive 100 that may pass through chassis 140 and enter power module 160 through a bottom portion of power module 160. Power connector 180 may be configured to connect a maximum number of power modules 160 to power system 150. According to some embodiments, the number of power modules 160 may be less than the number of power modules 160 required to operate locomotive 100. In addition locomotive 100 may also include one or more fasteners configured to removably connect power modules 160 to chassis 140, thereby facilitating addition or removal of power modules 160 from chassis 140.

Power connector 180 may include all the necessary connection lines for operably coupling each power module 160 to other subsystems of locomotive 100. According to some embodiments, a locomotive fuel supply line may be provided to connect to a power module fuel supply line via a fuel supply line connecter. Additionally or alternatively, a locomotive air supply line may be provided to connect to a power module air supply line via an air supply line connector, and/or a locomotive traction power line (e.g., a direct current power line) may be provided to connect to a power module traction power line via a traction power connector. A locomotive accessory power line may be provided to connect to a power module accessory power line via an accessory power line connector. A locomotive battery power line may be provided to connect to a power module battery power line via a battery power line connector. A locomotive control wiring line may be provided to connect to a power module control wiring line via a control wiring connector. Any number of power lines may be included on power connector 180 for connecting power modules 160 to locomotive 100.

Power connectors 180 may include various types of connectors including, for example, a hose quick disconnect connector (e.g., connecting fuel supply lines), a hose screw-on connector (e.g., connecting air supply lines), a bolt-on cable lug connector (e.g., connecting traction power lines, accessory power lines, and battery power lines), and a wiring connector (e.g., connecting control wiring lines). While the above-listed connector types may be implemented in the some embodiments, it is contemplated that the connection of lines of power module 160 may include any type or number of connectors sufficient to connect power module 160 to locomotive 100. During installation of power module 160 on locomotive 100, one or more of the connection lines of power connectors 180 may be connected via a corresponding connector between power module 160 and locomotive 100. Likewise, during removal of power module 160 from locomotive 100, one or more of the connection lines may be disconnected.

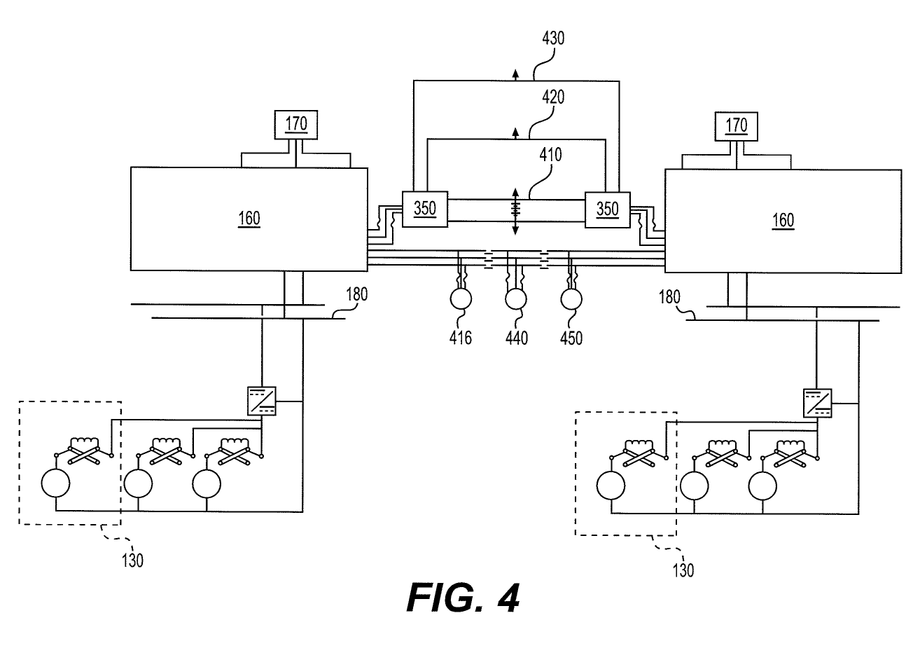

FIG. 4 illustrates an exemplary embodiment of power system 150 including two power modules 160 configured to at least partially power locomotive 100. According to some embodiments, two power modules 160 have the same physical dimensions as one another. In this embodiment, two power modules 160 are connected to six traction motors 130. While power connector 180 may connect each power module 160 to three traction motors 130, the implementation of power system 150 may instead connect all power modules 160 to all loads, or connect each module 160 to subsets of the loads. For example, both power modules 160 shown in FIG. 4 are connected to a direct battery load 410, a critical auxiliary load 420, and a non-critical auxiliary load 430. As shown in FIG. 4, other components of locomotive 100 may also be connected to power modules 160, including, for example, a pressure sensor 416, an air compressor 440, and a blower 450.

As shown in FIG. 1, locomotive 100 may also include a controller 170 for controlling the operation of power system 150. Controller 170 may embody a single processor or multiple processors that include a means for communicating data signals. Additionally or alternatively, controller 170 may control a portion or all of power system 150. Numerous commercially available processors can be configured to perform the functions of controller 170. It should be appreciated that controller 170 could readily embody a general machine or customized processor capable of controlling the operation of power system 150. Controller 170 may include all components required to run an application, such as, for example, a memory, a secondary storage device, and a processor, such as a central processing unit or other known means. Optionally, controller 170 may include other known circuits, including power source circuitry and other appropriate circuitry. Controller 170 may be configured to receive and transmit signals, as well as perform calculations.

In some embodiments, the powering configuration and/or the command signal may be based on other or additional data. For example, controller 170 may determine a power characteristic of each of power modules 160. According to some embodiments, this may include a maximum power output (or maximum output voltage or current), and/or a power rating. Based on the power characteristics, controller 170 may identify a primary power module of a plurality of power modules.

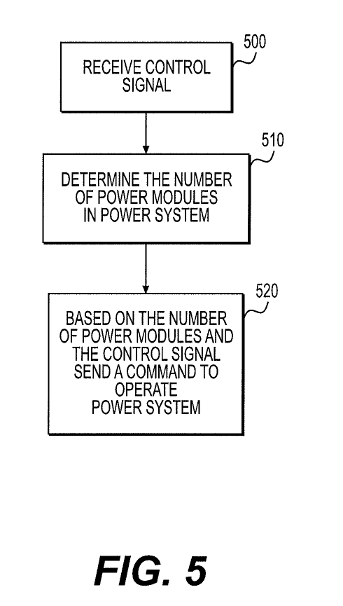

FIG. 5 is a flowchart of a computer-implemented method of controlling locomotive 100 that can be implemented by, for example, controller 170. At step 500, controller 170 may receive a control signal indicative of a powering mode of locomotive 100. For example, the control signal may be indicative of at least one of, braking, decelerating, accelerating, reversing, powering, or powering off locomotive 100 being powered by power system 150. The control signal may be generated by other subsystems of locomotive 100, and/or may be provided by operator input. The control signal may further be indicative of additional information, such as the power requirements of locomotive 100. That is, depending on its load (not shown), locomotive 100 may require more power to accelerate than it would need with a different load. Controller 170 may optionally receive this information via the control signal. Additionally or alternatively, controller 170 may calculate or determine the power requirements of locomotive 100 based on, for example, the relative incline of the railway on which locomotive 100 is traveling (with respect to the force of gravity), the weight of locomotive 100, and/or the weight of the load locomotive 100 is carrying.

At step 510, controller 170 may determine a number of power modules in locomotive 100 (and/or its power system 150). According to some embodiments, controller 170 may include one or more sensors or data input signals that indicate the number of power modules 160 that are operably connected to power connector 180. Determining the number of power modules 160 may include checking multiple signals, such as confirming that power lines as well as communication lines for each power module 160 are operating and/or connected. For some embodiments, confirming one aspect (e.g., that power is being output by each power module 160) may be sufficient.

Based on the number of power modules 160 and the control signal, controller 170 may determine a powering configuration of power system 150 to output power to satisfy the power requirements of locomotive 100. The powering configuration may be based on additional characteristics of power system 150 and/or power modules 160, including the power ratings of power modules 160. The powering configuration may include a set of one or more instructions or modes regarding how power system 150 should operate. At step 520, controller 170 may send a command signal to power system 150 to operate power system 150 according to the powering configuration. The command signal may be indicative of the powering configuration and/or the locomotive powering mode.

During operation, controller 170 may also be configured to detect a power module failure. For example, controller 170 may detect that one or more power modules 160 is no longer connected and/or no longer outputting power. Controller 170 may be further configured to re-determine the powering configuration for the power system to provide power required by the locomotive, taking into account the power module failure.

### Industrial Applicability

The disclosed system and methods may provide an ability to quickly tailor the power capacity of a locomotive to the load or weight characteristics of the locomotive. For example, locomotives can be built in a modular fashion for quick tailoring to satisfy the particular weight and power requirements of a particular use. Some or all of the power components may be contained in a modular and removable system, such as a power module.

The presently disclosed locomotive may have several advantages. For example, a locomotive using the disclosed power system can be quickly tailored to operate using greater or fewer power modules, depending on the requirements of a particular application. This customization process may be greatly simplified, as removing the power module may simply involve disconnecting the cables and lifting the module off the chassis of the locomotive. Furthermore, the removal or addition of a power module may be performed without the disruption of other portions of the locomotive, as the power module may be lifted upwards and placed on (or removed) from the locomotive, unlike other systems that would require the placement of components to be rearranged, thus requiring the movement of rail components across the tracks, which adds to the complexity (and time) of reconfiguring the locomotive.

It will be apparent to those skilled in the art that various modifications and variations can be made to the disclosed power modules and locomotive design and associated methods. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A locomotive comprising:
a plurality of axles;
a plurality of pairs of wheels, each of the wheels being connected to one of said axles;
a plurality of traction motors, each traction motor operably attached to at least one of the axles;
a power system including at least one power module, the power system being configured to provide power to the traction motors; and
a controller configured to:
receive a control signal indicative of a locomotive powering mode;
determine a number of power modules operably connected to the power system; and
based on the number of power modules operably connected to the power system and the control signal, send a command signal to the power system for operating the power system.

2. The locomotive of claim 1, further including a power connector configured to:
connect a maximum number of power modules, wherein the maximum number is greater than one; and
connect the power system to the plurality of traction motors.

3. The locomotive of claim 1, further including at least one balancing weight configured to balance the locomotive when the power system includes fewer power modules than the maximum number of power modules that the power connector is configured to connect.

4. The locomotive of claim 1, wherein the control signal is indicative of at least one of braking, decelerating, accelerating, reversing, powering, or powering off.

5. The locomotive of claim 1, wherein the controller is configured such that the control signal is provided by operator input.

6. The locomotive of claim 1, further including a rectifier configured to couple at least one power module to a battery load.

7. The locomotive of claim 6, wherein the rectifier is further configured to be connected to a non-critical auxiliary load and a critical auxiliary load.

8. The locomotive of claim 1, wherein the at least one power modules includes two power modules having the same physical dimensions.

9. A computer-implemented method of controlling a locomotive having a power system including at least one power module, the method comprising:
receiving, via a controller, a control signal indicative of a locomotive powering mode;
determining a number of power modules operably connected to the power system; and
based on the number of power modules operably connected to the power system and the locomotive powering mode, sending, via the controller, a command signal to the power system configured to operate the power system.

10. The computer-implemented method of claim 9, further including determining a power configuration of the power system that will enable operation of the locomotive powering mode, wherein the command signal is based on the power configuration.

11. The computer-implemented method of claim 10, further including:
determining a power characteristic of each of the power modules;
identifying a primary power module of the power modules based on the power characteristics; and
if power required by the locomotive powering mode is less than a maximum power output of the power system, determining power configuration that results in the primary power module outputting more power than a second power module of the power system.

12. The computer-implemented method of claim 11, further including:
detecting a power module failure; and
re-determining the powering configuration for the power system to provide power required by the locomotive taking into account the power module failure.

13. A power system comprising:
a power connector configured to be able to operably connect a maximum number of power modules, wherein the maximum number is greater than one;
at least one power module operably connected to the power connector;
a controller configured to:
receive a control signal indicative of a locomotive powering mode;
determine how many power modules are operably connected to the power connector; and
based on the number of power modules operably connected to the power connector and the control signal, control the power system.

14. The power system of claim 13, further including at least one balancing weight configured to balance a vehicle including the power system, wherein the number of the at least one power modules operably connected to the power connector is less than the maximum number of power modules the power connector is able to operably connect.

15. The power system of claim 13, wherein the power connector is further configured to couple a plurality of power modules to a load.

16. The power system of claim 13, wherein the control signal is indicative of at least one of braking, decelerating, accelerating, reversing, powering, or powering off.

17. The power system of claim 16, wherein the controller is configured such that the control signal is provided by an operator input.

18. The power system of claim 13, further including a rectifier configured to couple at least one power module to a battery load.

19. The power system of claim 18, wherein the rectifier is further configured to be connected to a non-critical auxiliary load and a critical auxiliary load.

20. The power system of claim 19, wherein the at least one power module includes two power modules having the same dimensions.
